(19) United States
(12) Patent Application Publication
(10) Pub. No.: US 2005/0080720 A1
(43) Pub. Date: Apr. 14, 2005

(54) Deriving security and privacy solutions to mitigate risk

(75) Inventors: Linda N. Betz, Poughkeepsie, NY (US); George R. Blakley III, Round Rock, TX (US); Donald A. Cronin, Raleigh, NC (US); David K. Hemsath, Round Rock, TX (US); Paul J. Landsberg, Raleigh, NC (US); Christopher R. O'Connor, Raleigh, NC (US); Ronald Perez, Mount Kisco, NY (US); James P. Ward, Apex, NC (US); Richard B. Wood, Austin, TX (US)

Correspondence Address: Gerald R. Woods;IBM Corporation, T81/503, PO Box 12195, Research Triangle Park, NC, 27709, US

(73) Assignee: International Business Machines Corporation, Armonk, NY (US)

(21) Appl. No.: 10/683,022

(22) Filed: Oct. 10, 2003

(51) Int. Cl. G06F 17/60

(52) U.S. Cl. 705/38

(57) ABSTRACT

Techniques are disclosed for systematically assessing an enterprise's security risks in view of a set of security patterns. Each pattern that is applicable to the enterprise's operation is then considered against the backdrop of a set of common attributes that are used, in turn, to further distinguish each pattern from a risk and security solution perspective. Using the disclosed techniques, specific security risks can be identified and appropriate security products can be selected to address those risks in a systematic manner, thereby assisting information technology decision makers across a wide variety of enterprises in deriving security solutions. These security solutions will typically be more effective and efficient from a functional perspective, as well as being more cost-effective, than security solutions created using prior art ad hoc approaches. The disclosed techniques may also be leveraged to create a requirements list for function to be included in a security product.

### BACKGROUND OF THE INVENTION

1. Field of the Invention

The present invention relates to systematic techniques for assessing security and privacy concerns for an enterprise, and deals more particularly with techniques for determining one or more information technology products and/or services that may be leveraged to mitigate security and privacy risks for the enterprise.

2. Description of the Related Art

Any enterprise, whether it is a commercial business, a government or military entity, an educational or charitable institution, or another type of enterprise, faces risks as part of conducting its operations. As used herein, the term “risk” or “business risk” denotes the possibility that something negative or undesirable will happen, and more particularly, denotes the possibility that something negative or undesirable will happen to the enterprise, its customers, or some asset or entity on which the enterprise depends. Typically, business risks are quantified in economic terms, such as a possibility of lost revenue, lost wages, or damage to the enterprise's reputation. An enterprise's reputation is also referred to herein as the enterprise's “brand” or “brand image”.

An enterprise may deal with business risks in a variety of ways. FIG. 1A identifies several types of business risks to an enterprise, and FIG. 1B identifies several risk management options for dealing with those risks. For any particular business risk, multiple risk management options may be employed. A complex interplay of factors is often involved in selecting appropriate risk management options, including the products/services deployed by an enterprise, the types of activities the enterprise conducts, the anticipated economic cost incurred if a loss occurs, and the cost of mitigating the enterprise's exposure to loss.

As shown in FIG. 1B, one option is risk mitigation. Risk mitigation involves employing various risk-reducing techniques, also referred to herein as security techniques, leading to a corresponding reduction in the likelihood of adverse economic impact to the enterprise and/or a reduction in the severity of the negative consequences that may be encountered if a loss occurs.

For example, before a financial institution allows its automated teller machines (“ATMs”) to dispense cash to a person presenting an ATM card, the institution typically requires the person to type in a password that is intended to be known only by the legitimate cardholder. The entered password is then compared to a password that is stored, in association with this ATM card's number, in a data repository. If the entered password does not match the stored password, then no cash will be dispensed. A number of other security techniques may be employed to further mitigate risks in this environment, such as encrypting transmission of the entered password as it travels from the keypad to the location where the comparison is performed.

In some enterprises, privacy of certain information must be protected, and therefore privacy techniques are typically implemented. The term “personally-identifiable information” or “PII” is often used in this context, referring to information held by an enterprise about people such as customers or employees. One way of protecting PII is to modify data values, thereby ensuring that an individual's PII becomes anonymous, before the data values are made available outside the enterprise or outside selected organizational units of the enterprise (such as the payroll department or human resources organization). Another way of protecting PII is to completely suppress the PII in transmissions outside the enterprise or selected organizational units.

Security and privacy solutions may be provided as products comprising hardware, software, firmware, or some combination thereof. Security and privacy products are typically not a “one size fits all” solution. Instead, these products are often directed toward solving specific problems in specific environments. Designing an appropriate security solution is often a daunting task, and in the current art, products in an enterprise's security solution are typically selected using an ad hoc “point technology” approach (i.e., where a product is selected to address a particular risk, without regard to how that product affects other risk factors or interacts with other security products or systems of the enterprise). As a result, many enterprises end up with an assortment of products that are costly, ineffective, and/or inefficient for mitigating risks.

Accordingly, what is needed are techniques for assessing security and privacy risks for an enterprise, and deriving a security solution that addresses those risks, in a systematic manner.

### SUMMARY OF THE INVENTION

An object of the present invention is to provide techniques for assessing security risks for an enterprise.

Another object of the present invention is to provide techniques for deriving a security solution for the enterprise, in view of its particular security risks.

A further object of the present invention is to provide techniques for systematically evaluating an enterprise, using predetermined criteria and attributes, with a view toward mitigating security risks of the enterprise.

Yet another object of the present invention is to provide techniques for systematically evaluating privacy concerns of an enterprise and addressing these privacy concerns in a solution adapted for that enterprise.

Still another object of the present invention is to systematically address security and/or privacy concerns that arise due to activities conducted by an enterprise over electronic media.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention defines techniques for systematically assessing security concerns of an enterprise. In preferred embodiments, an enterprise's security risks are assessed in view of a set of security patterns (and optionally, a set of sub-patterns). Each pattern that is applicable to the enterprise's operation is considered against the backdrop of a set of common attributes that are used, in turn, to further distinguish each pattern from a risk and security solution perspective. Using the disclosed techniques, specific security risks can be identified and appropriate security products can be selected to address those risks in a systematic manner, thereby assisting information technology decision makers across a wide variety of enterprises in deriving security solutions.

The present invention may also be used advantageously in methods of doing business, as will be described in more detail with reference to preferred embodiments.

The present invention will now be described with reference to the following drawings, in which like reference numbers denote the same element throughout.

### BRIEF DESCRIPTION OF THE DRAWINGS

FIG. 1A identifies several types of business risks to an enterprise, and FIG. 1B identifies several risk management options for dealing with those risks;

FIG. 2 depicts enterprise security patterns used in preferred embodiments of the present invention;

FIG. 3 shows security attributes used in preferred embodiments of the present invention;

FIG. 4 provides a grid wherein representative values of the security attributes in FIG. 3 are provided for each of the security patterns in FIG. 2;

FIGS. 5, 7, 9, 11, and 13 illustrate, in more detail, the enterprise security patterns that were depicted in FIG. 2;

FIG. 6 provides a chart that depicts a set of generic security components that may be used in preferred embodiments of the present invention;

FIGS. 8, 10, 12, and 14 illustrate sub-patterns of the patterns shown in FIGS. 7, 9, 11, and 13, respectively;

FIGS. 15-17 provide flow diagrams illustrating how preferred embodiments may be carried out; and

FIG. 18 illustrates use of preferred embodiments with a fictional enterprise.

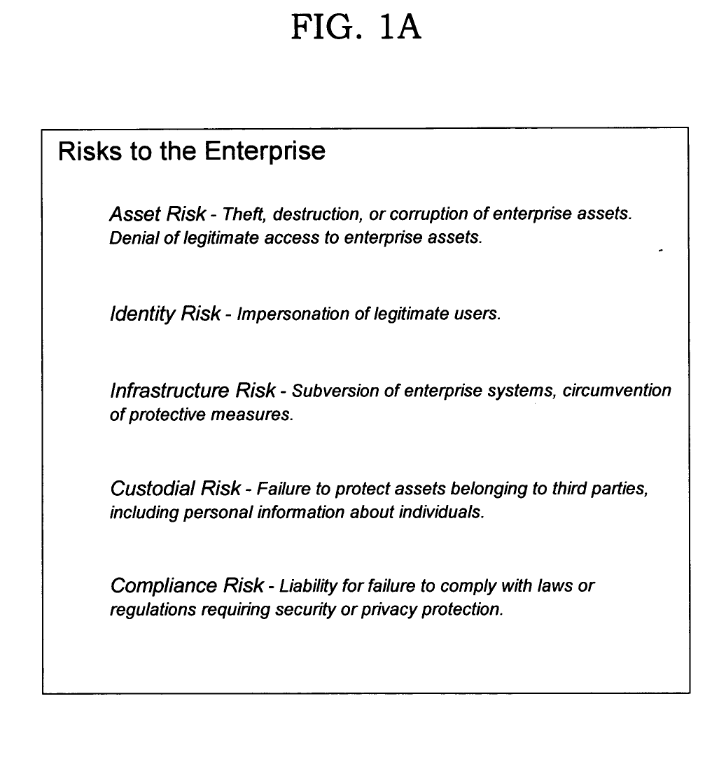

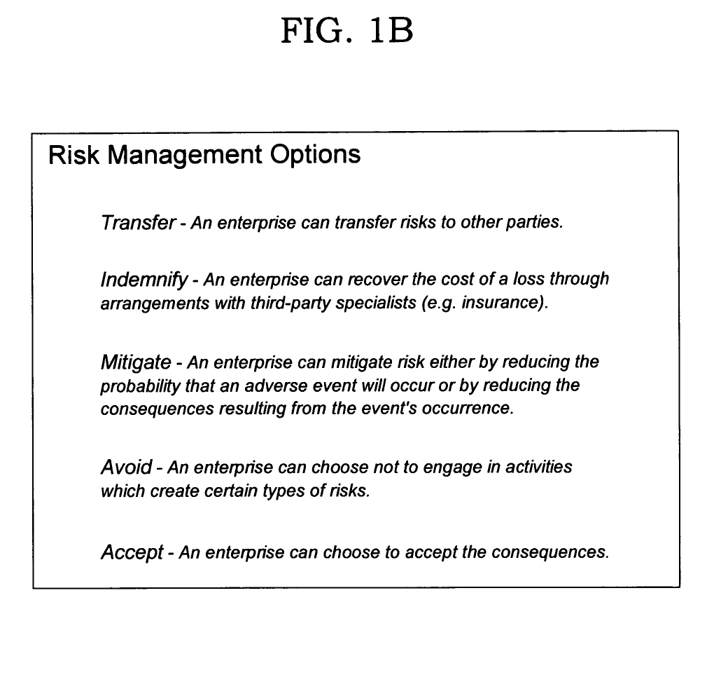

### DESCRIPTION OF PREFERRED EMBODIMENTS

The present invention provides techniques for assessing security and privacy concerns for an enterprise in a systematic manner. Techniques are disclosed for identifying information technology (“IT”) products that may be leveraged to provide a solution that mitigates security and privacy risks for the enterprise. By selecting products systematically as described herein, a more effective and efficient security solution can be realized, typically at lower cost, than using prior art ad hoc techniques.

Privacy concerns of an enterprise are often mitigated using techniques similar to those that mitigate security risks, as will be described in more detail below. Therefore, for ease of reference, the term “security” as used hereinafter should be interpreted as including both security and privacy considerations unless the context of the reference indicates otherwise.

Efficient and effective security is an integral part of an enterprise delivering value. Enterprises require security for their own operations as well as for their interactions with customers and partners. Identifying and understanding the relationships between the risks inherent in a particular enterprise process and the security products or services that best address those risks is key to deriving an appropriate security solution.

Of particular importance to the present invention are those risks which are involved when an enterprise conducts activities over electronic media. For example, an enterprise might make data publicly available over a network such as the Internet by establishing a Web presence (e.g., by setting up a Web site where information can be viewed by the public). Another example of conducting activities over electronic media are the so-called “B2B” and “B2C” (i.e., business-to-business and business-to-consumer) forms of electronic commerce that have become prevalent in recent years, whereby an enterprise may conduct transactions with business partners and consumers over a communications network such as the Internet.

The risks involved with conducting activities over electronic media depend on various factors associated with the enterprise. Therefore, according to preferred embodiments of the present invention, an enterprise is first classified as to one or more “enterprise security patterns” that best represent the enterprise's activities which involve electronic media. Five predominant enterprise security patterns, referred to equivalently herein as “security patterns” or simply “patterns”, have been defined for use in preferred embodiments. (Alternatively, an implementation of the present invention may use fewer or more than five patterns, and those patterns may be defined with characteristics that differ from those disclosed herein, without deviating from the scope of the present invention.)

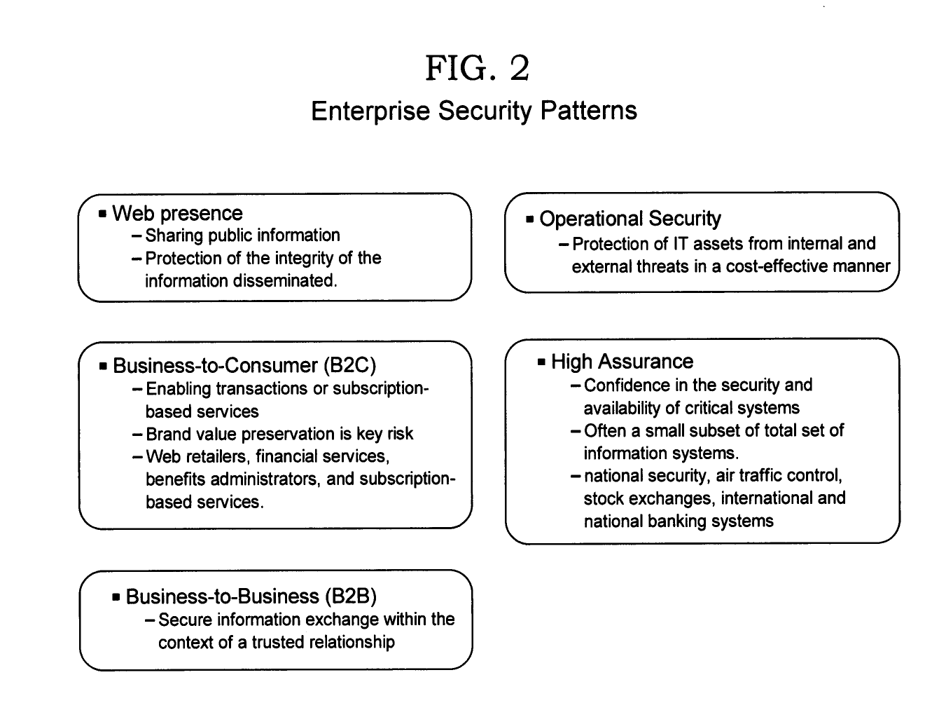

The five security patterns used in preferred embodiments are referred to herein as “Web Presence”, “Business to Consumer” or “B2C”, “Business to Business” or “B2B”, “Operational Security”, and “High Assurance”. FIG. 2 presents key characteristics of each of these five patterns. It should be noted that more than one of these patterns may apply to a particular enterprise. Using the systematic techniques disclosed herein to address each applicable security pattern when assessing an enterprise's risks, a comprehensive security solution can then be developed for the enterprise.

To evaluate the risks associated with a particular security pattern, preferred embodiments use eight attributes as decision points. (Alternatively, an implementation of the present invention may use fewer or more attributes, and those attributes may be defined with characteristics that differ from those disclosed herein, without deviating from the scope of the present invention.) When evaluating a security pattern, use of these attributes enables one to better understand risk characteristics of that pattern. The eight attributes discussed herein pertain to risk-management considerations involving key business needs, system elements, and assets that require security. The specific attributes of a particular security pattern enable identifying the countermeasures that an enterprise may take to reduce risk to an acceptable level (as will be described in more detail below). Sub-patterns are disclosed herein for several of the security patterns, as will be described in more detail below, and these eight attributes may also be used with the sub-patterns. The eight attributes used in preferred embodiments are directed toward answering the following questions:
1) Who is the other party in the activities?
2) What type of access point is the other party using?
3) What type of access method is the other party using?
4) What type of access portal does the enterprise provide for these activities?
5) What type of collateral access might occur when these activities are being conducted?
6) What does the data value depend on in these activities?
7) What type of PII is at risk (i.e., what are the privacy considerations)?
8) What assurance level does the enterprise need for the risks involved in these activities?

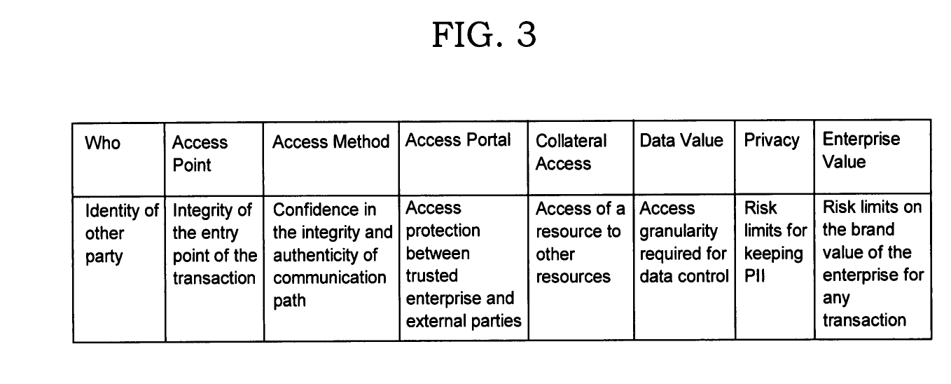

These eight attributes, and their characteristics, are presented in FIG. 3. When evaluating risk using the eight attributes, properties of those attributes may vary, depending on the pattern under consideration. More particularly, the intent of the attributes may be described as follows:

1) Who—the degree of confidence the enterprise has in the identity of the other transacting party.

2) Access Point—the degree of confidence the enterprise has in the integrity of the entry point into the transaction.

3) Access Method—the degree of confidence the enterprise has in the confidentiality, integrity, and authenticity of the communication path between the transacting parties.

4) Access Portal—the degree of protection the transition point provides between the enterprise and the untrusted external environment.

5) Collateral Access—the degree to which access to a particular resource can enable other unauthorized resource actions.

6) Data Value—the degree of granularity required for access control to the data, or the value of the data itself.

7) Privacy—the business risks associated with maintaining and using PII and/or maintaining the confidentiality of other proprietary information (for example, confidential information of the enterprise or its business partners).

8) Enterprise Assurance Level—the degree to which the brand value of the enterprise can be affected by modification, disclosure, or destruction of assets or the unauthorized unavailability thereof. Also included is the level of assurance required by the enterprise that exposures will not occur.

Each enterprise security pattern is used to describe an aspect of one or more enterprise activities that have a level of associated risk, and in preferred embodiments, the enterprise activities of interest are those involving electronic media, as noted above. An enterprise's risk parameters are described in terms of the risk attributes, for each security pattern that is applicable to the enterprise. This information can then be mapped into organized structures that provide a template for effectively implementing a security solution. In this manner, use of enterprise security patterns and risk attributes, as disclosed herein, provides a powerful methodology for identifying and understanding relationships between the risks an enterprise encounters when conducting activities over electronic media and the components of a security solution for that enterprise, thereby enabling the enterprise to maximize the value of its security investment.

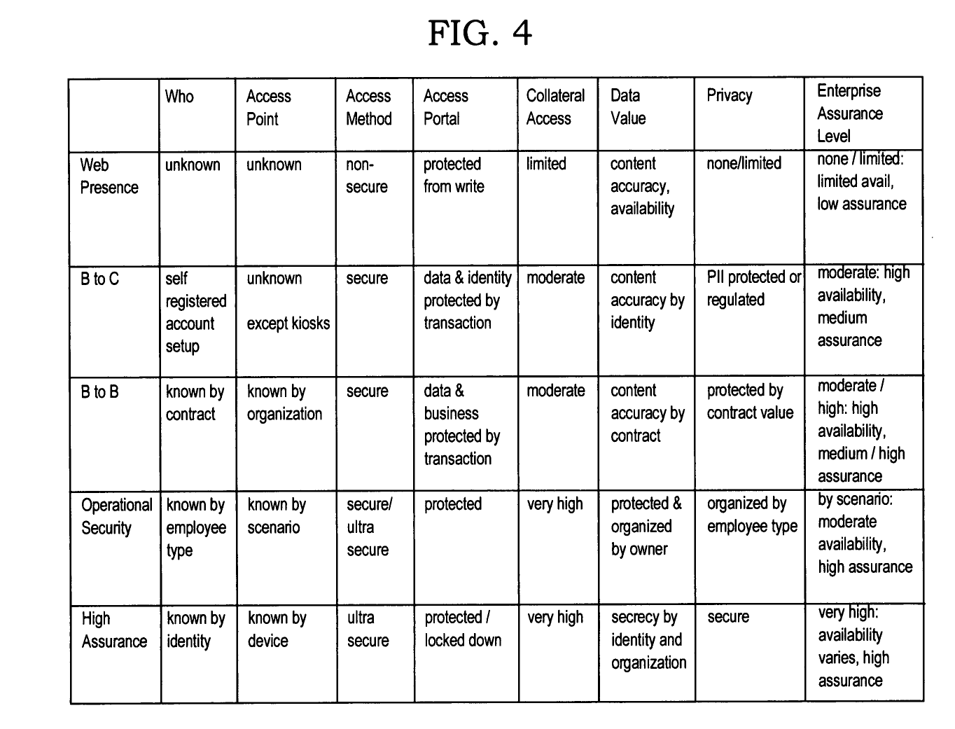

FIG. 4 shows a 5-by-8 grid wherein the five security patterns are mapped against the eight risk attributes. Each cell in this grid describes, in general terms, characteristics that are applicable to the intersection of its corresponding security pattern and risk attribute. According to preferred embodiments, each of these characteristics is evaluated when deriving an enterprise's security solution. For example, in the “Web Presence” pattern, the value depicted in the “Who” column is “unknown”, indicating that the identity of the other party involved in these activities has not been validated except, perhaps, with relatively simple methods. This becomes one factor used in determining a security solution for an enterprise that has a Web presence.

The manner in which the security patterns, risk attributes, and grid are used in preferred embodiments will now be described in more detail.

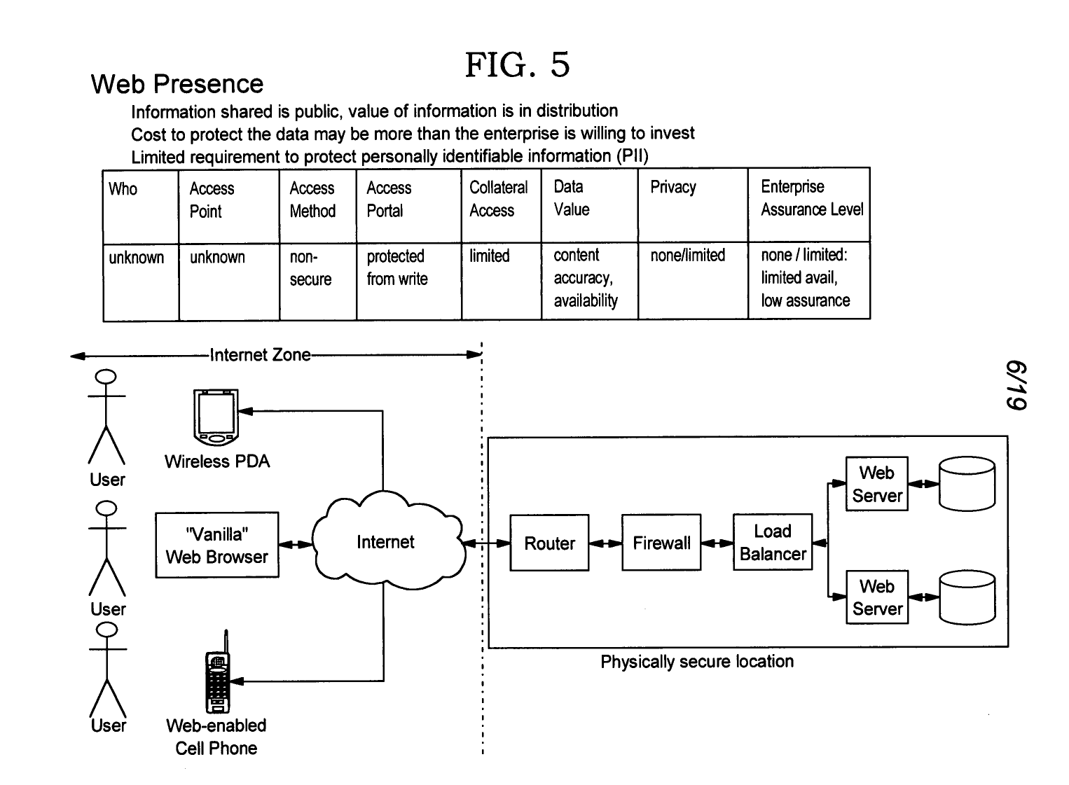

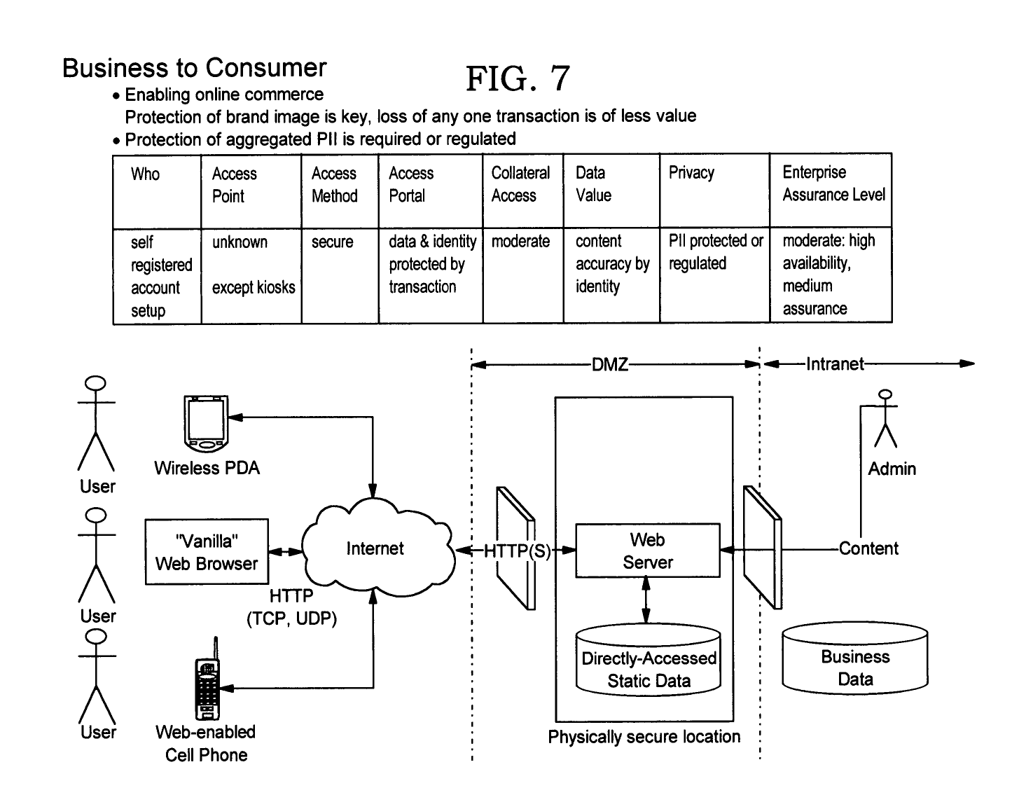

Referring now to FIG. 5, the first of the five enterprise security patterns, “Web Presence”, is presented. (Note that the values in the cells of FIG. 5 were previously presented in FIG. 4. Similarly, the values in the cells of FIGS. 7, 9, 11, and 13 were also presented in FIG. 4.) As noted above, an enterprise's Web presence is typically provided through data that is publicly available over the Internet from that enterprise (for example, via an Internet-based information portal). For purposes of discussion herein, the activities deemed to be within the Web Presence pattern are non-transaction-oriented activities. (If an enterprise allows its customers to perform activities through its Internet portal such as purchasing goods or services, security aspects of those activities are addressed using the B2C pattern. Similarly, if an enterprise transacts business with business partners using the Internet, those activities are addressed using the B2B pattern. In preferred embodiments, an enterprise's Internet transactions with its employees, such as payroll and benefits applications, are addressed in the B2C pattern.) With reference to non-transaction-oriented activities, the goal of an enterprise's Web presence is to provide Internet-based access to the enterprise's public information. Key operational characteristics of the Web Presence pattern are therefore that (1) the information shared is public and (2) the value of the information is in its public dissemination. Accordingly, the value of the data value can be negatively impacted if problems arise with its availability or its integrity (as indicated in the “Data Value” cell of FIG. 5).

An enterprise generally has little control over who accesses the enterprise's Web presence, or the access points they use. Usually, the access points are Web browsers running on traditional personal computing devices or on pervasive devices such as personal digital assistants (“PDAs”) and Internet-capable cell phones, as shown in the lower left portion of FIG. 5. The cells for the “Who” and “Access Point” attributes are therefore shown in FIG. 5 as “unknown”. The enterprise generally does, however, control the access method used for its Web presence. Often, the access method is a Hypertext Transfer Protocol (“HTTP”) session established over a Transmission Control Protocol/Internet Protocol (“TCP/IP”) session. Even though the user and access point may be generally unknown, a relatively low risk to the enterprise is presented because the information to be obtained is public information. Therefore, the sessions are typically not secure, as indicated in the “Access Method” cell of FIG. 5.

To ensure that an enterprise's Web presence presents limited opportunity for attackers, the portal used for dissemination of Web presence data should be protected from write operations of those accessing the site (as noted in the “Access Portal” cell in FIG. 5). A major risk for an enterprise that typically arises in this pattern is harm to the image and value of the enterprise's brand. Two types of threats generally exist. First, the data to be disseminated via the Web presence might not be available (due, for example, to a denial-of-service attack or the destruction of the information to be presented). Second, the data might be corrupted, as in a site defacement attack. In view of these types of threats, a basic goal of security in the Web Presence pattern is therefore to protect the integrity and the availability of the information to be disseminated. (See the “Data Value” cell in FIG. 5, which was discussed above.)

Preferred embodiments further divide the Web Presence pattern into two sub-patterns, which are referred to herein as “Isolated from Core Business” and “Integrated with Core Business”. The “Collateral Access” cell in FIG. 5 will now be described with reference to these two sub-patterns.

If an enterprise's Web presence is appropriately isolated from the enterprise's core business (e.g., there is no connectivity from the Web presence to the enterprise's intranet), then access to other collateral data (e.g., data used by the enterprise's other systems) does not exist. The primary concern is then the integrity and availability of the data being presented, as discussed above. On the other hand, if the Web presence enables connectivity to the enterprise's intranet or other systems (and is therefore considered as “integrated” with the enterprise's core business), then security vulnerabilities may lead to unintended network and/or systems access, which is termed “collateral access” herein. This collateral access potential leads to additional exposures, and therefore the “Collateral Access” cell of FIG. 5 is indicated as “limited” due to these exposures. In preferred embodiments, these risks, threats, and vulnerabilities are addressed in the context of the Operational Security pattern (using a composite pattern approach, wherein the fact that collateral access is enabled is considered to be an operational security issue arising from an enterprise's Web presence). The Operational Security pattern is the fourth pattern, and is discussed below.

Because the information provided through an enterprise's Web presence is public information, there are generally no privacy issues involved, and thus the “Privacy” cell in FIG. 5 indicates “none” or “limited” for the applicable security concerns. (Note that the privacy concerns for the enterprise are increased if the Web presence is in the “integrated with core business” sub-pattern whereby collateral access may occur.)

Finally, the “Enterprise Assurance Level” cell in FIG. 5 indicates that an enterprise generally needs a relatively “low assurance” of protection against exposures due to its Web presence activities. This cell also indicates that “limited availability” of Web presence data is tolerable, with the risk to the enterprise if the Web presence is unavailable being “none” to “limited”.

By reviewing the entries in the eight cells in FIG. 5 (which are a subset of the grid in FIG. 4, as noted above), it can be seen how activities in an enterprise security pattern are mapped against the eight attributes. A set of decisions on risk can then be made at each cell, enabling the enterprise to systematically address its security solution within that particular security pattern. For example, an enterprise might consider whether its Web presence is integrated with its enterprise systems and if so, whether collateral access potential results in any security exposures for this particular enterprise. If there are security exposures, the IT decision makers for the enterprise can then determine whether the risk is tolerable and, in making that decision, can weigh the costs of products or measures that would remove or reduce the risk (e.g., by deploying the Web presence m a manner whereby it is isolated from the enterprise systems).

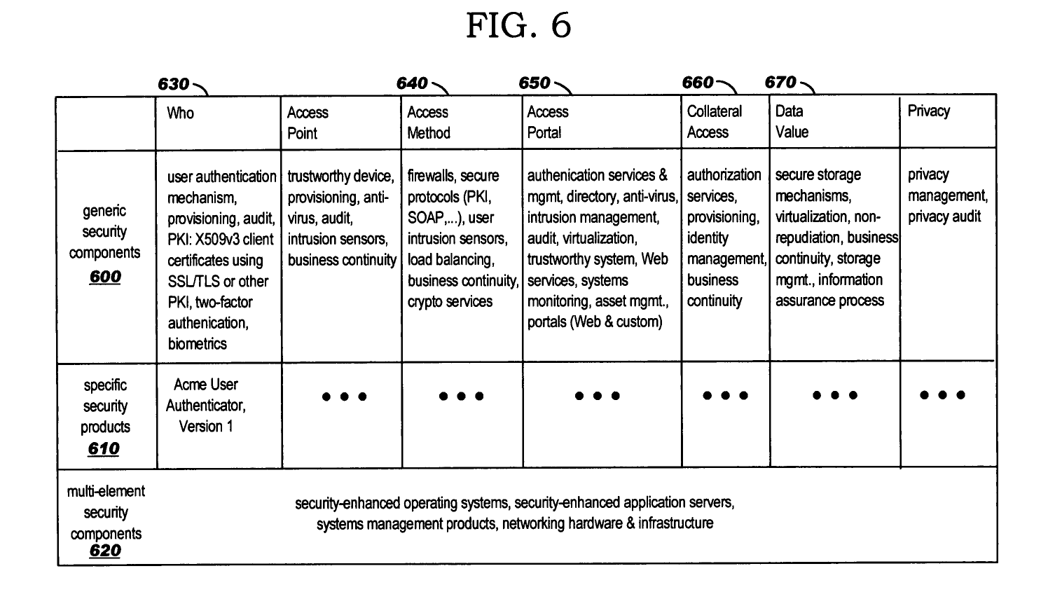

Preferred embodiments use a grid or chart, illustrated in FIG. 6, which provides (inter alia) a set of “generic security components” for this decision-making process. These components are illustrated in row 600, with reference to the eight attributes. For example, column 630 indicates that risks associated with knowing who the users are (within activities of a particular security pattern) may be addressed by selecting security products that provide one or more of: a user authentication mechanism; provisioning (e.g., whereby functions of a system are specially adapted or configured for particular users or user groups); auditing (e.g., tracking who the users are); public key infrastructure (“PKI”) techniques such as use of X.509 client certificates with secure access protocols such as the Secure Sockets Layer (“SSL”) or Transport Layer Security (“TLS”); two-factor authentication mechanisms; or user identification through biometrics. As will be obvious, the generic security component(s) that are appropriate for addressing risks in the different security patterns may vary widely. Biometric identification, for example, would not generally be a cost-effective or efficient technique for addressing risks presented in the Web Presence pattern where publicly-available information is being disseminated. On the other hand, biometrics might be very well suited for use in other security patterns. Accordingly, the systematic cell-by-cell analysis used in preferred embodiments enables IT decision makers to assess their risks and to select one or more suitable techniques from among the generic security components.

Selecting which generic security components are appropriate for addressing the enterprise's risks then facilitates selection of one or more “specific security products” (row 610). Security products leveraged by the present invention may be embodied in hardware, software, firmware, or some combination thereof. (Furthermore, references herein to security products should be interpreted as also including security services where appropriate, such as out-sourced monitoring operations. For example, an enterprise might contract with a third party to analyze audit data captured as users access enterprise systems. In addition, in some cases, non-technical countermeasures may provide appropriate risk mitigation, and these non-technical approaches may be included as potential components of a security solution. As one example, use of contracts containing specific terms and conditions may be appropriate risk-mitigation techniques in a B2B environment. References herein to selecting security products are also intended to encompass these non-technical countermeasures.)

In an actual implementation of the present invention, a set of specific security products is preferably identified for the cells in row 610, where the entry in each cell specifies a pre-determined product or products that provide(s) at least some portion of the function represented by the generic security components for the corresponding column. A sample product, “Acme User Authenticator, Version 1”, is identified in column 630 of row 610 as a specific product for performing user authentication. When the remaining cells in row 610 are filled in with specific security products as well, the IT decision makers can easily and systematically select products to provide a security solution for the enterprise.

It may happen that a particular security product addresses risks in multiple security patterns and/or risks among multiple attributes. For example, “user authentication” is a generic security component appearing in column 630 and column 650, and “provisioning” is a generic security component appearing in column 630 and column 660. Therefore, a particular authentication product might be listed in columns 630 and 650, and a provisioning product might be listed in both columns 630 and 660. An enterprise may be able to reduce the cost (as well as the complexity) of its security solution by selecting such “cross-listed” products.

In some cases, the “Enterprise Assurance Level” attribute does not map directly to components and products. Instead, this attribute may be used as a type of overriding factor or wildcard, whereby the IT decision makers of an enterprise apply discretion in selecting generic security components and/or specific security products in view of the Enterprise Assurance Level attribute.

When IT product developers undertake development of a new security product or enhancements to an existing product (or, alternatively, development of a requirements list therefor), the cell-by-cell analysis approach disclosed herein may be used to succinctly identify functional requirements for the new or enhanced product. Preferably, a chart such as that shown in FIG. 6 is used, where the entries in row 610 may be omitted. The product developers may use the generic security components as guidelines in deciding what functions should be included in the development effort. For example, if a new product is to directed toward eliminating security exposures related to a particular access method, the developers may choose to provide a specialized product which is adapted only for that purpose. Alternatively, they may evaluate the relative advantages and disadvantages of extending the product functions to address other attributes such as the access portal. Furthermore, the developers may evaluate whether the product's function should be focused on the risks inherent in one particular security pattern, or in contrast, whether they wish to address risks across multiple security patterns. Use of this structured approach for identifying product requirements, whereby a product is “placed” into one or more specific cells, allows a clearer focus on the target environment and ensuring that the needs of that environment will be met by the finished product.

Whether using the chart in FIG. 6 for evaluating an enterprise's security solution, or using it to identify functions for inclusion in security products, the cell-by-cell evaluation disclosed herein will be advantageous. (As an alternative to using this grid format, the pattern-to-attribute correspondence may be specified in some other way without deviating from the scope of the present invention.)

Returning now to the discussion of evaluating a security solution, a set of “multi-element security components” may optionally be provided in this chart (as illustrated in row 620). Components identified in this set address security risks that are applicable across multiple attributes. For example, row 620 indicates that security-enhanced operating systems, security-enhanced application servers, systems management products, and selected networking hardware and infrastructure components may be leveraged to provide protection against risks. An additional row (not shown) may also be provided in the grid of FIG. 6, identifying specific multi-element security products. For example, the IBM® z/OS® operating system might be identified as a specific security-enhanced operating system, and the IBM® eServer™ zSeries® 990 might be identified as a specific security-enhanced server. (“IBM”, “z/OS”, and “zSeries” are registered trademarks, and “eServer” is a trademark, of International Business Machines Corporation.)

When provided, the multi-element security components and specific multi-element security products are also preferably considered by the IT decision makers when developing an enterprise's security solution.

Preferred embodiments use the chart shown in FIG. 6 for all five of the security patterns, as described above. Alternatively, various cells in the chart in FIG. 6 may be specifically adapted for individual security patterns; or, an implementation of the present invention may use separate versions of this grid, where each version has been specifically adapted for one or more of the security patterns.

As one example of how the chart in FIG. 6 may be used to develop of an enterprise's security solution, the IT decision makers for an enterprise may wish to mitigate access method risks. By consulting the entries in column 640, it can be seen that one of the generic security components for dealing with access method risks is the use of firewalls. As described with reference to FIG. 5, an enterprise may use a non-secure access method for its Web presence data. Firewalls may be deployed as security barriers to create a “neutral zone” (often referred to as a demilitarized zone or “DMZ”) between the enterprise's intranet and a non-secure network such as the Internet, in order to protect the enterprise's data and to attempt the mitigation of exposures such as denial-of-service attacks. Thus, the IT decision makers for the enterprise might choose to deploy firewalls to mitigate (at least partially) the risks of using a non-secure access method for Web presence data. (The diagram in the lower right portion of FIG. 5 illustrates use of one firewall, for purposes of illustration.)

As another example of how the chart in FIG. 6 may be used to develop a security solution, suppose the IT decision makers for this same enterprise wish to provide additional protection for the availability and integrity of the enterprise's Web presence data. The entries in column 660 indicate that storage management components are one technique for protecting an enterprise's data value. Thus, a high-availability server solution may be employed inside an enterprise's DMZ to mitigate availability risks whereby the enterprise's brand might be damaged if its Web presence data was not available for dissemination. (The high-availability server solution is represented generally in the lower right portion of FIG. 5 by the presence of redundant Web servers and a load balancer that routes incoming requests among those redundant servers.)

Note that the entries in the chart in FIG. 6 are intended to be illustrative, and not exhaustive. It should also be noted that the security patterns and attributes that are important to an enterprise's electronic media activities may change over time. In addition, the generic security components and/or multi-element security components with which corresponding risks can be mitigated may also change over time, and the specific security products that are available for an IT decision maker to select will almost certainly change over time. Therefore, embodiments of the present invention preferably provide flexibility in the assessment of a security solution and, in particular, in the security patterns and attributes that are evaluated, and how those are mapped to components and products to derive a security solution. Furthermore, embodiments of the present invention preferably leverage an iterative approach whereby the security assessment is periodically repeated to ensure that an enterprise's already-deployed security solution remains effective in view of changes that may have occurred to the enterprise's operations, the risks inherent in those operations, and/or security products that are available for mitigating those risks.

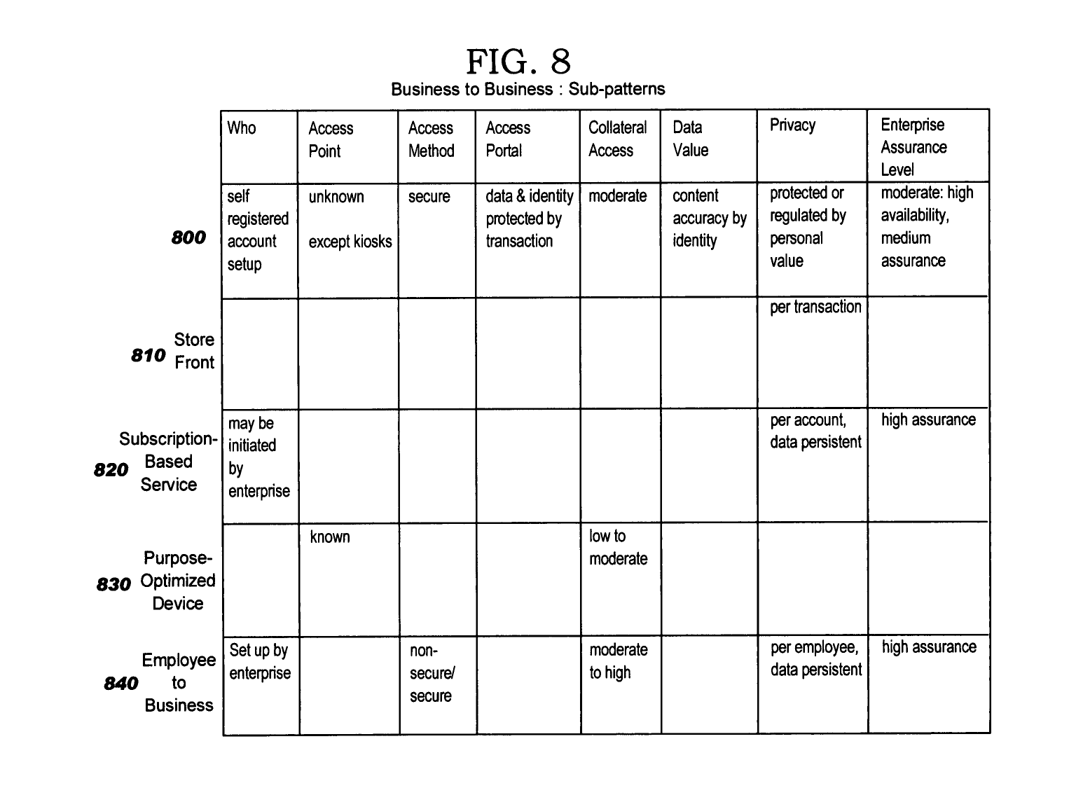

Returning now to discussion of the five security patterns, the next of these patterns is the “B2C” pattern, which is represented by FIG. 7. This pattern generally encompasses an enterprise's ability to conduct transactions with, or on behalf of, customers over networked systems. The values provided in cells of the eight attributes in FIG. 7 describe representative cases of the B2C pattern, and more specific cases of this pattern are depicted in FIG. 8 (described below) with reference to four sub-patterns of the B2C pattern.

B2C operations of an enterprise may enable individuals to engage in on-line commerce. Other activities which are considered as being within the realm of the B2C pattern include using networked systems to manage personal data such as accounts, e-mail, collaboration, and employee benefits. Examples of enterprises characterized by the B2C pattern are Web retailers, financial service enterprises, enterprises providing benefits administration, and subscription-based services such as providers of e-mail telematics (i.e., a combination of telecommunications and computing), personalized information, and so forth. Providers of data with long-term value, such as games and movies, are also considered to be within the B2C pattern.

Preferred embodiments therefore define four sub-patterns that further divide the B2C pattern, which are referred to herein as “Store Front”, “Subscription-Based Services”, “Purpose-Optimized Devices”, and “Employee-to-Business”. These sub-patterns are depicted by the grid in FIG. 8, and will be described following the description of the B2C pattern in general.

As noted in FIG. 7, the B2C pattern is characterized by on-line commerce operations, and a basic goal of this pattern is to preserve the value of the enterprise's brand image. Although accuracy of transactions is important to that image, the value for any one transaction is often limited and therefore a single transaction does not generally present a major risk. In the aggregate, however, the loss or misuse of data may have a catastrophic impact to the brand image. FIG. 7 also notes that the protection of the aggregated PII maintained by an enterprise in the B2C pattern is typically regulated or required by law.

A characteristic of the B2C pattern is that the enterprise's customers are typically identified to the B2C function using a self-registered account setup (as indicated in the “Who” cell in FIG. 7), and generally access the enterprise using a secure access method (as indicated in the “Access Method” cell) from a variety of access points which are generally not mandated or specified by the enterprise (as indicated in the “Access Point” cell using the shorthand notation “unknown”). The “Access Portal” cell of FIG. 7 notes that the access portal in B2C operations must generally provide transaction-based protection of customers' data and identities.

The “Access Point” cell in FIG. 7 also indicates that there are exceptions to the general case where the consumer's access point is unknown. The term “kiosk” is used in FIG. 7 to represent these exceptions. Kiosks are further described below with reference to row 830 of FIG. 8.

Generally, there is a moderate risk due to collateral access in the B2C activities (as indicated in the “Collateral Access” cell of FIG. 7). As shown in the “Data Value” cell, a basic goal of security in the B2C pattern is to protect the accuracy of content according to each customer identity. An enterprise typically retains PII regarding its B2C customers, and as indicated in the “Privacy” cell, regulations and/or laws often require this PII to be protected. (In other cases, the need to protect customers' PII may arise from competitive or ethical considerations.)

Lastly, the “Enterprise Assurance Level” cell of FIG. 7 indicates that an enterprise generally needs a relatively “medium assurance” that it is protected against risks in its B2C pattern. This cell also indicates that “high availability” of B2C is generally expected, with the risk to the enterprise if the B2C activities are not available being “moderate”.

Turning now to the task of selecting products to mitigate risks in the B2C pattern, the particular characteristics of the pattern (as exemplified in FIG. 7) are preferably used in an analogous manner to that described above for FIGS. 5 and 6. For example, because users in the B2C pattern must generally create an identity through some registration process, as stated above, it is advisable to use products that accurately identify who the customer is. Referring to the “Who” column 630 of FIG. 6, one way in which this may be accomplished is to use a security product providing user authentication (as noted in the generic security components for this column). Depending on the type of B2C transactions being performed, a selection of an appropriate authentication mechanism for verifying a user's identity can then be made. Common techniques are use of user identification and password, smartcards, browser cookies, or third-party user authentication. Some enterprises may provide B2C transactions that required third-party authentication. If this is required, the scenario resembles a B2C transaction in parallel with a B2B transaction that occurs in the background (i.e., between the enterprise and a third-party enterprise that provides the authentication service).

The assets to be secured in this B2C pattern are generally PII, account access information, information presented to the consumer, and links that enable the access between the consumer and the enterprise. Major threats in the B2C pattern are impersonation of legitimate users by imposters, collateral access to an enterprise's systems, and misuse of personal data. Attacks based on these threats may originate from inside or outside the enterprise. Referring generally to FIG. 6, the generic security components that may be employed as countermeasures for these threats include anti-virus technology, access control, authentication control, authorization control privacy management, intrusion detection, firewalls, and encrypted information (e.g., encrypted transactions, encrypted links, and so forth). These security components may be implemented in various ways, including as OS-embedded functions, special-purpose security appliances, software programs running on an enterprise's IT infrastructure, or some combination thereof.

Turning now to FIG. 8, the four sub-patterns of the B2C pattern will be described. (Note that where empty cells appear in FIG. 8, this indicates that the value is inherited from the cell in row 800 where a value is specified for general cases within this same column. The cells in row 800 were described above with reference to FIG. 7.)

An enterprise characterized as having a “store front” sub-pattern (see row 810 of FIG. 8) is engaged in transactions with customers in a networking environment. There may not be a long-term relationship between the enterprise and the customer in some cases, and therefore the privacy issues in this sub-pattern are generally concerned with “per-transaction” information (as noted in the “Privacy” cell of row 810 of FIG. 8). Typically, the value of any one transaction in this sub-pattern is relatively limited.

An enterprise characterized as offering “subscription-based services” (see row 820 of FIG. 8) engages in a long-term relationship with the customer. Therefore, relevant data is persistent, and privacy concerns are therefore higher in this sub-pattern. The “Privacy” cell of row 820 therefore indicates that privacy concerns are the protection of persistent data on a per-account basis. In some cases, activities occurring in this sub-pattern may be initiated by the enterprise, rather than by the customer, as indicated in the “Who” cell of row 820. In these cases, it may happen that risks involved with user identities are reduced. Account management functions are also considered to fall within the characteristics of the subscription-based services sub-pattern. An enterprise providing subscription-based or account-management transactions may wish to guard against access to other enterprise systems, in which case data separation concerns are higher (not shown in FIG. 8).

The “Enterprise Assurance Level” cell in row 820 indicates that an enterprise generally requires relatively “high assurance” that it is protected against exposures in this subscription-based B2C sub-pattern.

An enterprise may provide B2C transactions via “purpose-optimized devices” (see row 830 of FIG. 8), which are referred to herein equivalently as “kiosks”. The term “purpose-optimized device” refers to a special-purpose endpoint (i.e., access point). The “known” shorthand notation specified in the “Access Point” cell in row 830 therefore indicates that the customer's access point typically meets specified characteristics which have been defined by the enterprise. These special-purpose endpoints are typically physically secure, and are typically required for those enterprises that must deliver tangible or long-term value to the customer, such as enterprises that deliver cash, tickets, vouchers, or games over a networked system. The endpoints may therefore be embodied as ATMs, various types of ticket-dispensing machines, and so forth.

When customers use a purpose-optimized device as their access point, their ability to access other enterprise systems is typically limited because the access points are often “fixed-function” devices. Accordingly, the “Collateral Access” cell in row 830 indicates that there is a low to moderate risk involved with collateral access. For example, a bank teller might use a fixed-function computing device for performing transactions on behalf of a bank's customers, preventing the teller from having general access to the bank's computing systems. Or, an employee in a manufacturing environment might use a particular type of device for interacting with plant floor operations, where this device presents only a limited number of functions to its operator. (The physical protection of a purpose-optimized access device is a separate security concern.)

In an enterprise that provides functions in the employee-to-business sub-pattern (see row 840 of FIG. 8), the employee (a consumer, in this context) may be physically located within the enterprise infrastructure when carrying out pertinent transactions, and ability to access the enterprise's employee-to-business functions is typically provided by the employer (as noted in the “Who” cell), enabling the enterprise to know who is accessing its systems. Depending on the activities that are provided, the enterprise may use a secure or a non-secure access method. Risks due to access of collateral systems are often moderate to high in this sub-pattern. The “Privacy” cell of Row 840 notes that the data of concern to this sub-pattern is persistent, and must be protected on a per-employee basis. The “Enterprise Assurance Level” cell for row 830 indicates that the enterprise needs security measures that provide a high assurance that data used in this sub-pattern will not be compromised. (An enterprise having this sub-pattern and its inherent risks will typically select security measures that include access and data separation controls.)

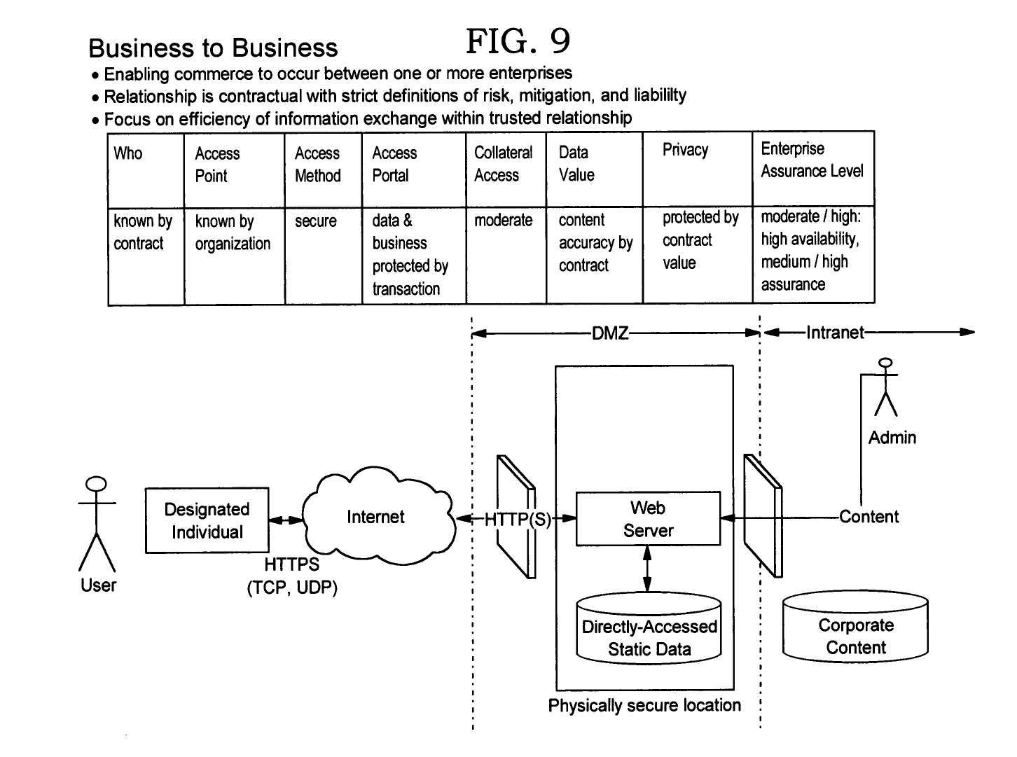

The third enterprise security pattern used in preferred embodiments, which is represented in FIG. 9, is the B2B pattern. Interactions in this pattern generally involve secure commercial transactions between one or more enterprises. Typically, a B2B transaction occurs under a contractual relationship between the parties, with either an explicit or implied agreement between the parties regarding risk, mitigation, and liability. A primary goal of the B2B pattern is to provide efficient and secure information exchange within the context of a trusted relationship.

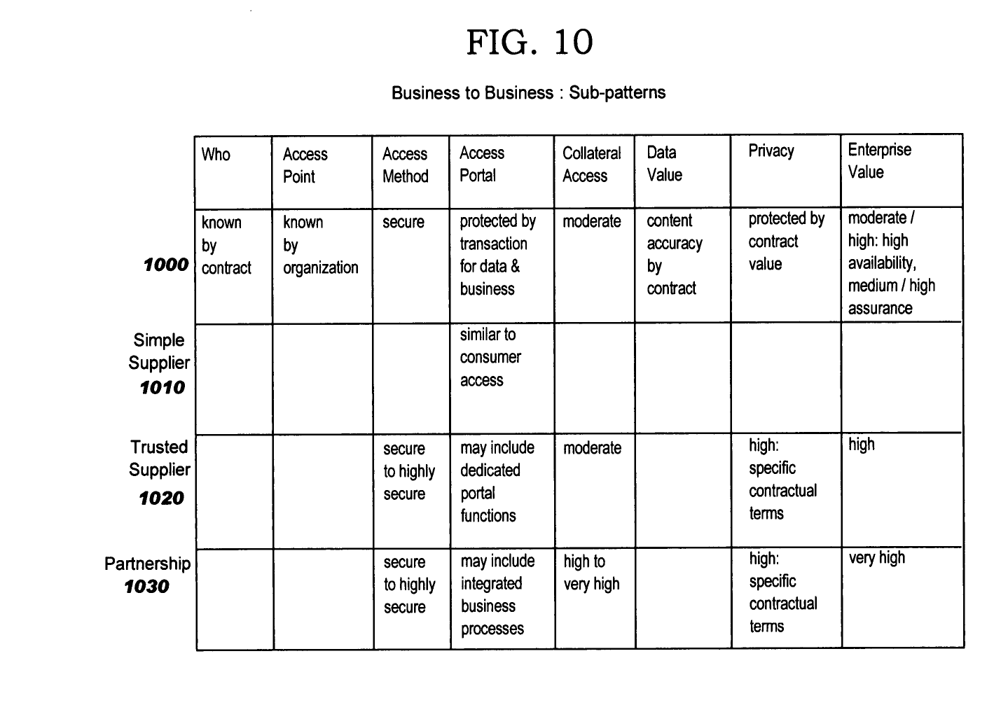

The values in the cells of FIG. 9 describe representative cases of the B2B pattern, and more specific cases of this pattern are depicted with reference to three sub-patterns presented in FIG. 10 (as described in more detail below).

The “Who” cell in FIG. 9 notes that the entity communicating with an enterprise in this pattern is generally known by way of contract, and the “Access Point” cell indicates that the device with which that entity accesses the enterprise's systems may, in some cases, be known as well. Typically, the parties use a secure access method for conducting the B2B transaction, and transaction-specific protection is typically applied to secure the data and the enterprise at the access portal. Moderate risk due to access to collateral systems may be present in the B2B environment.

Accuracy of data exchanged between the parties must be protected, and similarly, any “private” data of the communicating entities (such as trade secrets or other confidential information, including details of the B2B transactions themselves) must be protected as well. As indicated in the “Data Value” and “Privacy” cells of FIG. 9, the contract between the parties typically specifies terms related to risks involved in these areas. The “Enterprise Assurance Level” cell notes that the value of the activities in this pattern necessitates a moderate to high availability of the pertinent information, and medium to high assurance of protection against exposures is needed. In addition, risk to the enterprise if the pertinent information is not properly protected is shown as moderate to high.

Preferred embodiments define three sub-patterns that further divide the B2B pattern, and those sub-patterns are referred to herein as “Simple Supplier”, “Trusted Supplier”, and “Partnership”. Each of these sub-patterns will now be described with reference to FIG. 10. (As explained with reference to FIGS. 7 and 8, values of cells provided for the general B2B case in FIG. 9 apply also in FIG. 10, except where more specific cell values are provided therein. Row 1000 of FIG. 10 repeats the values shown in FIG. 9, for ease of reference.)

An enterprise characterized as having a simple supplier relationship with another communicating entity, as represented by row 1010 of FIG. 10, generally communicates with that entity for the purpose of a business transaction. In many cases, the data that is being shared when operating in this mode is not of a sensitive nature (for example, ordering information), so it may or may not be encrypted. Security, as an embedded attribute of B2B relationships, is typically employed to assure that the point of entry into the enterprise is protected from unwanted intrusion attempts and from malicious code entering the enterprise's infrastructure. The “Access Portal” cell of row 1010 therefore indicates that this sub-pattern is similar to the B2C access portal issues which were noted in FIGS. 7 and 8.

When an enterprise communicates with others as a trusted supplier (see row 1020), the sensitivity of the data increases. As an example, a hospital communicating sensitive medical data to an insurance company about a patient operates in a trusted supplier mode. A secure to highly-secure access method is therefore typically needed, and privacy concerns regarding the communicated data are generally high (and may be controlled by specific contractual terms). During a trusted-supplier transaction, one enterprise may need to access data on a system belonging to another enterprise, and risks due to collateral access are therefore moderately high. The enterprise may choose to allow access only through an access portal that provides specific functions which are dedicated to the scope of the trusted supplier relationship. As indicated in the “Enterprise Assurance Level” cell of row 1020, risks to an enterprise operating in this sub-pattern are relatively high.

Types of general security components (see FIG. 6) that are well suited to addressing concerns in the trusted supplier sub-pattern include authorization, access control, and auditing mechanisms.

When operating in the partnership sub-pattern (see row 1030), data becomes shared data between the communicating entities. Therefore, a secure to highly-secure access method is typically used, and the access portal may allow transactions with the communicating entities to operate as integrated business processes. As a result, risks due to access of collateral systems are generally high to very high. Privacy concerns in this sub-pattern are generally high, and may be controlled by specific contractual terms. The data sharing and collaboration encountered in this sub-pattern lead to increased security exposures for the enterprise, and its risks are characterized in the “Enterprise Assurance Level” cell of row 1030 as “Very High”.

The B2B sub-patterns generally lead to common security exposures, which are present with varying degrees of risk. Generic security components that can be used as countermeasures to mitigate the risks include intrusion detection systems, firewalls, authorization and access control systems, and separation-of-content tools. The increasing sensitivity of data in the trusted supplier or partnership sub-patterns may escalate the need for security measures such as Virtual Private Networks (“VPNs”), secure e-mail, and independent third-party audits.

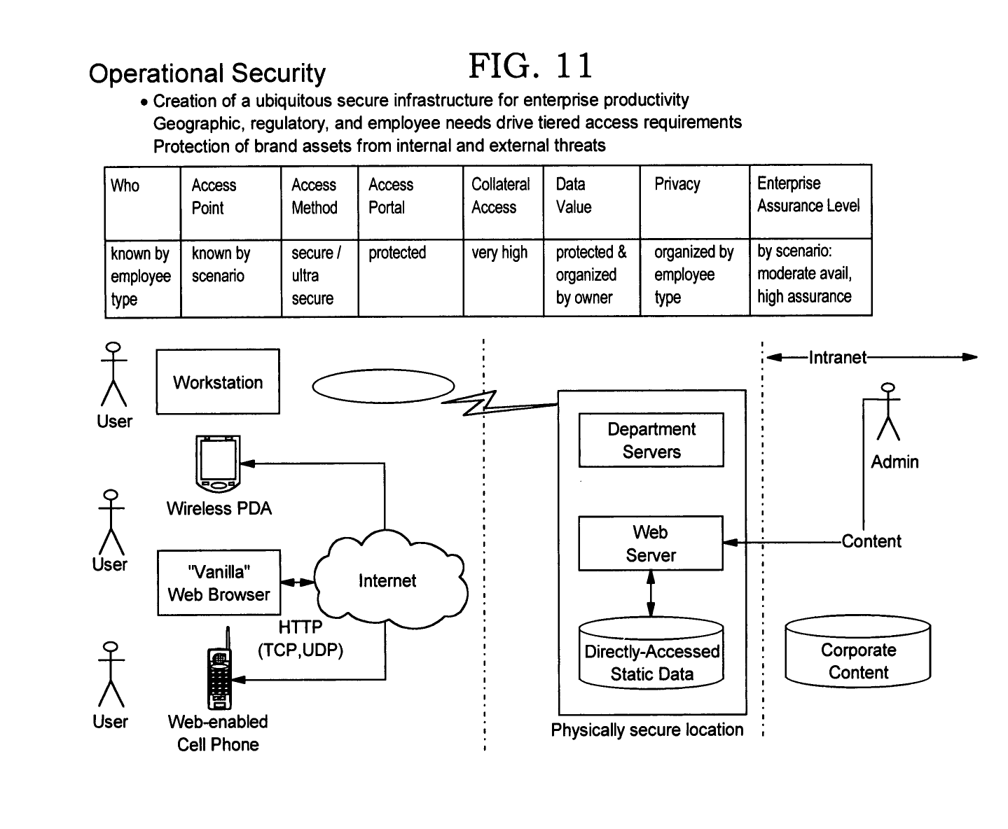

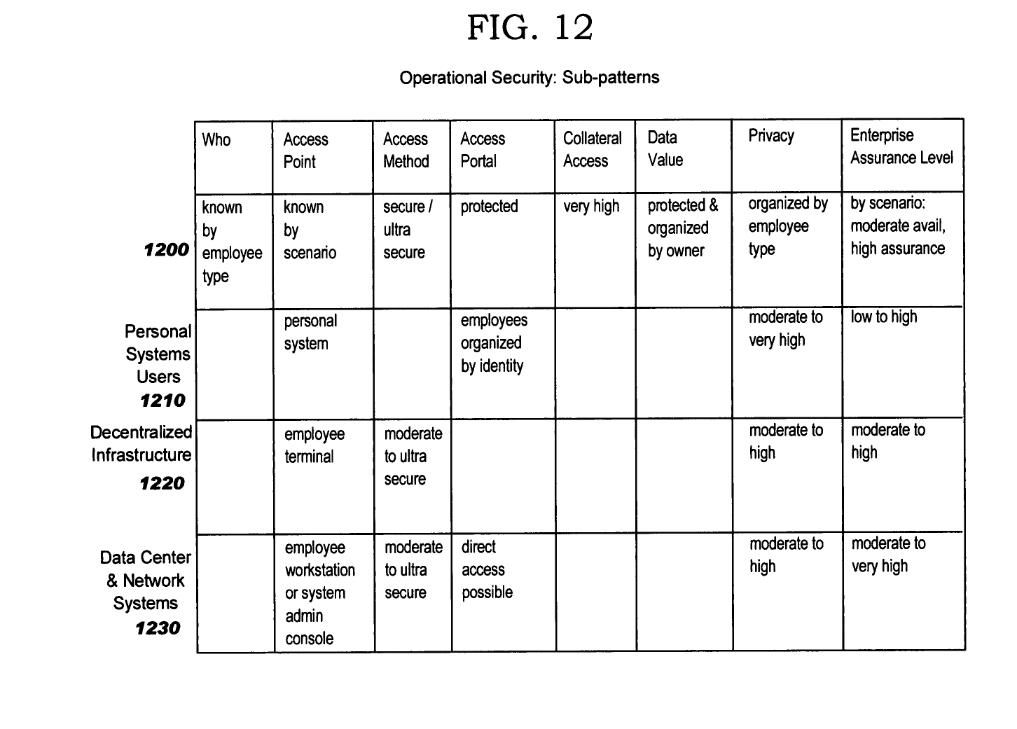

Operational security is the fourth security pattern used in preferred embodiments, and is represented generally in FIG. 11. (Note that the term “operational security” is not used herein with the same connotation as that term is used from a military or intelligence perspective.) Sub-patterns of operational security are presented in FIG. 12, and are discussed below.

Operational security concerns encompass generally all of the internal information technology components—software, platforms, network infrastructure, etc.—that an enterprise uses to execute its day-to-day operations. A primary goal in the operational security pattern is to ensure that an enterprise's internal systems and infrastructures meet required levels of security. Key drivers for operational security often include geographic, regulatory, and employee needs, along with tiered access to information. Another primary goal of this pattern is protection of the enterprise's brand from internal and external threats in a cost-effective manner.

The users in this pattern are generally known to the enterprise, typically by employee type, as indicated in the “Who” cell of FIG. 11, and the access points used are generally known according to the scenario of a particular access. For example, in a scenario where configuration values for computing devices within the enterprise are being modified, it may happen that an enterprise limits this capability to users classified as “systems administrator” and/or those using a device classified as “admin console” (where various security measures may be employed to verify these classifications). The access portals used in this pattern are generally protected, as indicated in the “Access Portal” cell, and access methods ranging from secure to ultra-secure are often used. The potential for risks due to collateral access is very high in this pattern, and data is generally organized and protected according to its owner (e.g., a department or organization that “owns”, or is responsible for, the data). The “Privacy” cell indicates that privacy concerns may be dealt with, in many cases, by organizing the data according to employee type. For example, access to certain sensitive enterprise data may be limited to users in the “management” classification or users in a classification such as “human resources”. An enterprise generally needs high assurance of adequate protection from risks in this sub-pattern, and, depending on the scenario involved, moderate availability of the data may be sufficient.

The generic security components that may be well suited for mitigating operational security risks in a particular enterprise include tools for controlling group access (e.g., ensuring that only users within a specified group or groups are allowed to access certain functions, where appropriate), tools for controlling internal and external access, and data segregation tools.

Referring now to FIG. 12, sub-patterns of operational security are referred to herein as “Personal Systems Users”, “Decentralized Infrastructure”, and “Data Center and Network Systems”. The decentralized infrastructure sub-pattern may be referred to equivalently as a “Department or Branch Office” scenario. An optional sub-pattern, not shown in FIG. 12, is “Manufacturing”. These sub-patterns will now be described with reference to their particular risks, threats, and vulnerabilities, and the applicable mitigating factors.

Users in the personal systems sub-pattern are considered to be inside the enterprise infrastructure, whether their physical location is remote from the enterprise or they are traditional in-house desktop users. As indicated in row 1210, the computing devices used as access points by these users are generally characterized as “personal systems”. Typically, these users have access to sensitive data, are unaware of software updates, are unskilled at security-related administration, and they are often members of multiple workgroups with varied privileges that must be managed. An enterprise may deploy its access portal so as to provide access to employees organized by identity. Privacy concerns in this sub-pattern are generally moderately high to very high. Risks to the enterprise from activities in this pattern may generally range from low to high.

Risks associated with users range from loss or theft of platforms/data (such as notebook computers or files) to maliciousness such as sabotage or corporate espionage. Threats and vulnerabilities include improper configuration of personal systems, introduction of viruses and threats from downloadable software (such as Trojan horses), and so forth. In addition, personal systems often contain a mix of personal and corporate data, and may provide the opportunity for non-employee access if the system is removed from the enterprise's premises, thereby further increasing the risk of exposure of sensitive or confidential enterprise information.

As used herein, the decentralized, or “branch office”, infrastructure (see row 1220) refers to a combination of network, server, and desktop systems that are not necessarily directly managed by the enterprise's IT security staff. These systems typically involve data that is specific to a particular enterprise or segment thereof, and tend to contain some aggregation of data without the strict controls of a data center. Access points are often an employee terminal device, which may connect to an access portal using an access method that ranges from moderately secure to ultra secure. Privacy concerns generally range from moderate to high, and there is generally a moderate to high risk to the enterprise from activities in this sub-pattern.

Typically, the risks involved in this branch office sub-pattern include unauthorized access to data, improper physical access to the systems, less timely system upgrades, unsecured wireless access, and poor controls on data separation and access.

Data centers (see row 1230) manage data that is of the highest value to the enterprise. Typically, they are centrally managed and are usually placed behind additional physical and logical barriers. Access points used in the data center sub-pattern are often employee workstations or system administrator consoles. Access methods may range from moderately secure to ultra secure, and direct access to the systems of the data center may be allowed (as noted in the “Access Portal” cell). Privacy concerns are typically moderately high to high, and risk to the enterprise in this sub-pattern is generally characterized as ranging from moderately high to very high.

Systems in the data center sub-pattern typically require tight security, as noted above, and when properly secured, the risk of unauthorized access or modification to data is small. Lack of data separation or sufficient access controls can result in catastrophic risk to the brand value by loss, exposure, and misuse of competitive secrets or private data.

“Network systems”, as the term is used herein, refers to various networking systems and related software that provide communications capability for the enterprise. These elements may be addressed separately from data centers, forming a distinct sub-pattern for each if desired, although they have been combined for purposes of illustration in FIG. 12. Risks involving network systems include threats to the physical security of the network itself, as the ability of enterprise components to communicate effectively is based on the network. The communications systems of an enterprise are typically subject to constant attack from external attackers who want to exploit any opportunities to gain access to the enterprise's infrastructure or to disrupt the normal operations of the enterprise.

The optional manufacturing sub-pattern deals with security concerns in an in-house manufacturing infrastructure (whether that infrastructure is owned by the enterprise or leased) that is dedicated to the production of tangible objects. (Security concerns pertaining to outsourced manufacturing, where manufacturing is done at a location other than the enterprise's location, is considered part of the B2B pattern.) Operations may be 24 hours per day, 7 days per week, and operational control systems pertaining to manufacturing are often connected to the enterprise's infrastructure (e.g., to provide asset management and control, access management, and so forth). Value to the enterprise of its manufacturing operations can be extremely high, since the manufacturing line often contains elements of trade secrets, intellectual property, and/or key operational data. A major risk involved with this type of operational infrastructure is disruption of the manufacturing line and the monetary consequences. Accordingly, products addressing risks inherent in this sub-pattern may be selected for incorporation in the enterprise's overall security solution.

Another security concern that may be dealt with under the operational security pattern is physical security. This term traditionally refers to protecting an enterprise's assets with “guns, guards, and gates”. Logical security may also be dealt with under this security pattern, and refers to techniques such as using access, authorization, and audit controls (often in conjunction with network monitoring systems). The convergence of physical and logical security may be enabled through technologies such as Radio Frequency Identification (“RFID”), biometric identification, and complex surveillance to control and/or monitor system access.

Countermeasures deployed to deal with risks to operational security may include: audit capabilities, software provisioning and version management, maintaining up-to-date anti-virus capabilities, protection of shared computing resources, intrusion detection, isolation of and recovery from security failures, as well as management of user access, authorization, and identities.

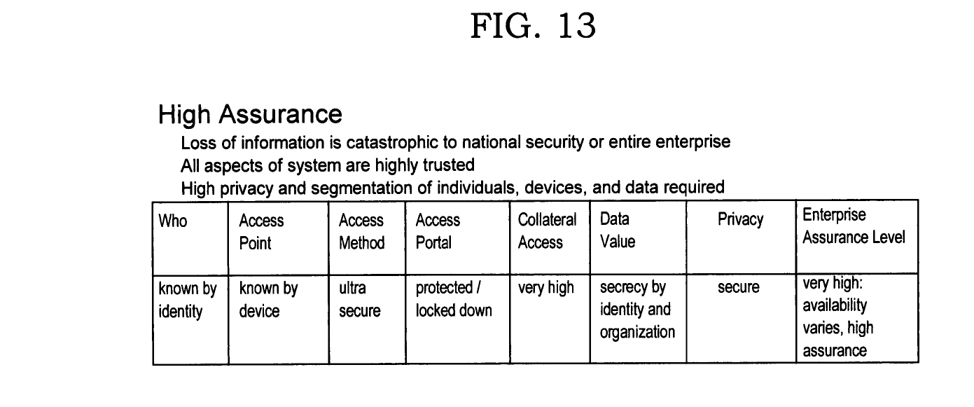

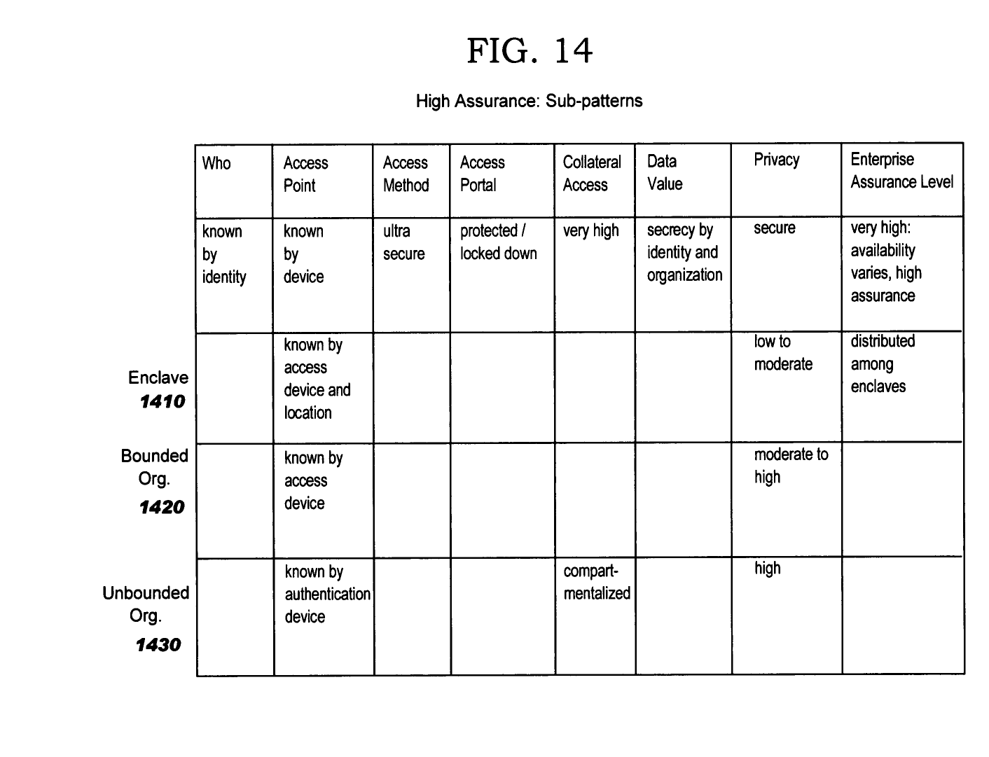

The last of the five security patterns used in preferred embodiments is the “High Assurance” pattern, which is represented in FIG. 13. Sub-patterns of this pattern are then described with reference to FIG. 14.

High assurance systems exist where it is necessary to be confident in the security and availability of critical systems. A more formal definition of a high assurance system, from the Carnegie Mellon Software Engineering Institute International Workshop on Requirements for High Assurance Systems 2002, is “a system where compelling evidence is required that the system delivers its services in a manner satisfying certain critical properties.” Government entities are often characterized by the high assurance pattern. Examples of high assurance systems include national security systems, air traffic control systems, stock exchanges, and international and national banking systems.

System users in the high assurance pattern are typically known to the system by their identity, and user access points are generally known by device. Ultra-secure access methods are typically used, and access points into high assurance systems are generally well protected (which may include locking down the access portals). Risks involved with collateral access are generally very high. Data value must generally be protected through per-identity and per-organization secrecy, and privacy concerns require PII to be strictly secure. An enterprise in this pattern generally needs a high assurance level that it is protected against exposures. While availability of high assurance systems may vary somewhat, risks to the enterprise are generally very high in this pattern.

General characteristics of a high assurance system include the following:

1) The system is secure: It prevents unauthorized disclosure, modification, and withholding of sensitive information.

2) The system is real-time: It delivers results within specified time intervals.

3) The system is survivable: It continues to fulfill its mission in the presence of attacks, accidents, or failures.

4) The system is fault-tolerant: It guarantees a certain quality of service despite faults, such as hardware, workload, or environmental anomalies.

5) The system is safe: It prevents unintended events that result in death, injury, illness, or damage to property.

The need for higher levels of assurance of protection against exposures in this pattern may arise from the sensitivity or value of the assets entrusted to an information system. The need may also (or alternatively) arise from the consequences of a system failure. With few exceptions, high assurance systems will be a small subset of an enterprise's total set of information systems. (Note also that security products developed for a high-assurance environment may eventually be deployed in other environments which do not strictly require such high assurance. Typically, this will happen if the product cost is reduced to a level that is affordable in those other environments.)

Multiple methods can be, and usually are, used to assure the integrity and availability of critical systems in this pattern. These include conformance testing, security evaluations, formal development methodologies, careful evaluation of an enterprise's prior experience or history, and contractual methods such as warranties. The specific assurance requirements and methodologies used will generally vary from one enterprise to another. There is typically a much higher cost to achieving the required levels of security, availability, and so forth, which is justified by the value of the assets at risk. That is, the cost of failure in high assurance systems is much greater than the cost of failure in other systems. Whereas risk in the previous security patterns was generally measured in economic terms, risk in the high assurance pattern may be measured in terms of human lives or injury to humans, loss or damage to physical systems, failure to deliver critical services in a timely manner (or to deliver them at all), compromise of national security, and/or significant economic losses.

Three sub-patterns are defined herein for the high assurance systems pattern, and these sub-patterns are referred to as “Enclave Environment”, “Bounded Organization”, and “Unbounded Organization”. Each of these sub-patterns will now be discussed with reference to FIG. 14.

In an enclave environment (row 1410), all security services are contained within a single “Trusted Computing Base.” A Trusted Computing Base, or “TCB”, is a tamper-evident or tamper-resistant, non-bypassable collection of hardware and software that enforces a defined security policy. Access points used in this sub-pattern are generally known by device as well as by location. For accountability, communicating pairs of applications preferably perform mutual authentication to guard against risk, and all resources are typically classified for sensitivity/value. All operations on classified resources are preferably recorded in secure logs (for example, in tamper-resistant or tamper-evident data repository). There is no network connection outside the trust boundary, so integrity and confidentiality of communicated data are not issues in this sub-pattern. However, with “trust nothing” as a root paradigm, in many cases, data will be protected in transit and in its permanent repositories. Privacy concerns are therefore indicated in row 1410 as low to moderate.

An enclave system may be a Multi-Level Secure (“MLS”) system, as defined by the Trusted Computing System Evaluation Criteria (“TCSEC”). The system may be evaluated under the “Common Criteria” defined in International Standard ISO/IEC 15408 (1999), “Information technology—Security techniques—Evaluation criteria for IT security”.

A bounded organization environment (see row 1420) comprises multiple trusted systems (e.g., multiple enclaves) linked by an isolated, trusted network. Because a network is connecting multiple trusted systems, a trusted third party may be introduced to provide mutual authentication and “over the wire” data protection (e.g., for integrity and confidentiality) of the network. The access points used in this sub-pattern are generally known by device, and risk to an enterprise is generally moderate to high.

In addition to the assurance methodologies discussed for the enclave environment, countermeasures appropriate for use in this sub-pattern include technology and procedures for verifying the network component, including intrusion detection systems, physical examination of the networks, and so forth.

Unbounded organization environments (row 1430) comprise bounded environments connected to public networks such as the Internet, which are presumed to contain untrusted users and systems in a non-secure environment. Access points used in the sub-pattern are generally known by authentication device, and collateral access concerns often involve compartmentalized data. Privacy concerns in this sub-pattern are often high.

Trusted segments of the unbounded network must defend themselves against attacks originating in untrusted segments. Security measures that may be leveraged for this purpose include use of firewalls, anti-virus utilities, cryptographic tunnels, intrusion detection/response, and other mechanisms.

A particular enterprise may have bounded and enclave environments that remain decoupled from the untrusted network.

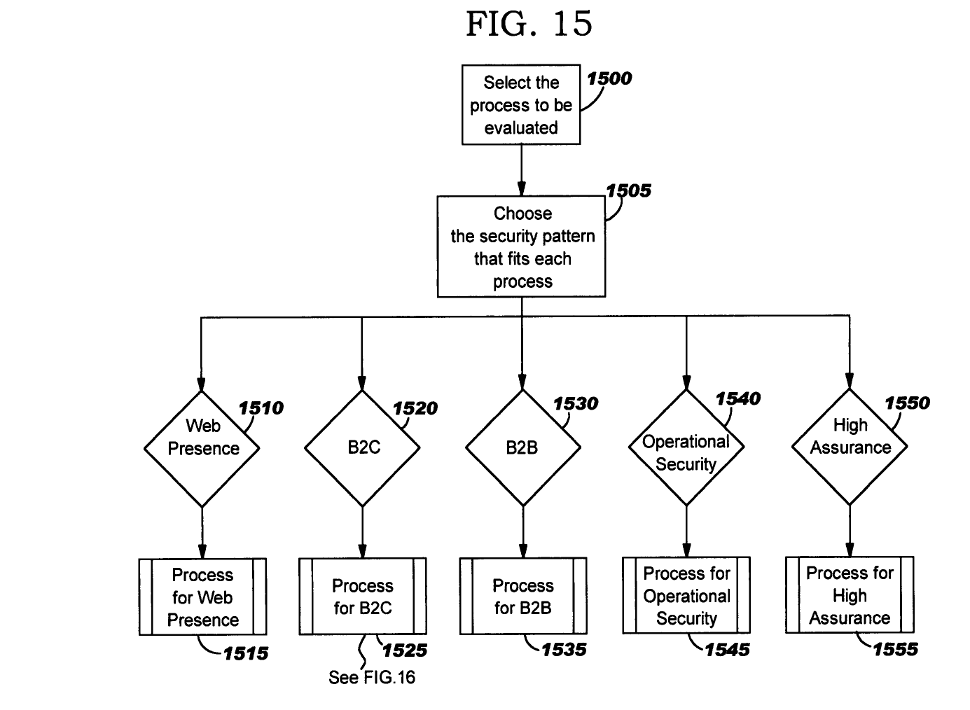

Turning now to FIGS. 15-17, flow diagrams are presented that illustrate how preferred embodiments may be carried out. These flow diagrams summarize discussions that have been provided above, and refer to the patterns and sub-patterns which have been described in detail herein. One or more processes (e.g., groups of activities involving electronic media) to be evaluated are selected (Block 1500), and each security pattern that is applicable to each process is identified (Block 1505). If the Web Presence pattern is applicable (Block 1510), then an evaluation of Web presence attributes is performed (Block 1515). Similarly, if the B2C or B2B pattern is applicable, then Blocks 1520 and 1525 or Block 1530 and 1535, respectively, deal with these patterns and their evaluations. If the operational security pattern is applicable (Block 1540), then an evaluation of attributes for that pattern is performed (Block 1545), and if the high assurance pattern applies (Block 1550), then an evaluation of high assurance attributes is performed (Block 1555).

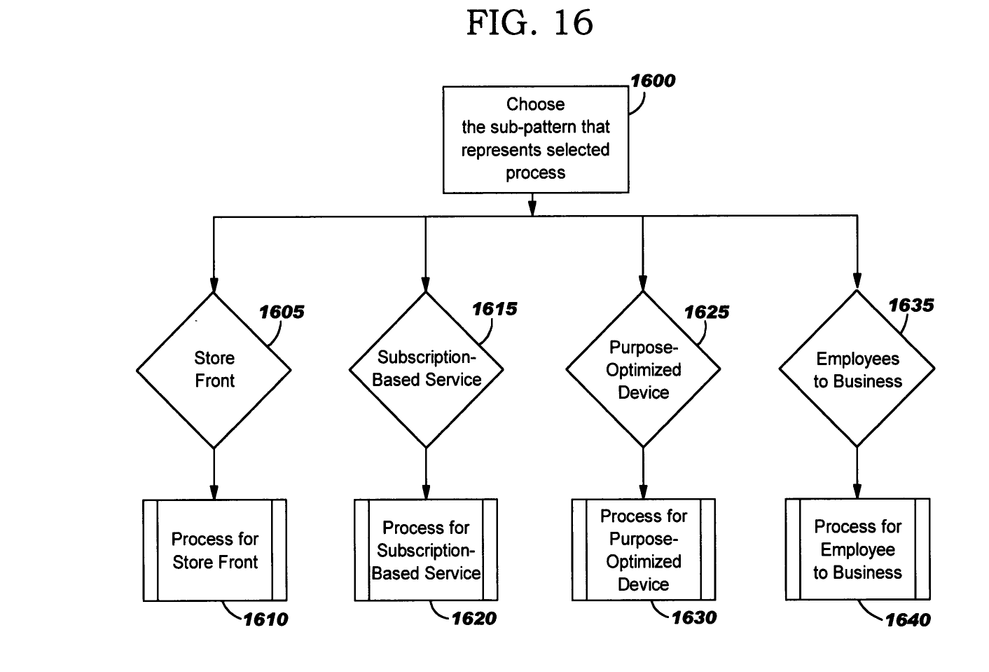

Note that for those patterns having sub-patterns, the evaluation preferably comprises first identifying one or more of the sub-patterns that is/are applicable. By way of illustration, FIG. 16 represents the sub-patterns for the B2C pattern. In Block 1600, the sub-pattern(s) that represent the process selected for evaluation is/are identified. The sub-pattern may be the store front (Block 1605), subscription-based service (Block 1615), purpose-optimized device or kiosk (Block 1625), or employee-to-business sub-pattern (Block 1635). Blocks 1610, 1620, 1630, and 1640 indicate that, based on which sub-pattern is applicable, an evaluation process is carried out for that sub-pattern.

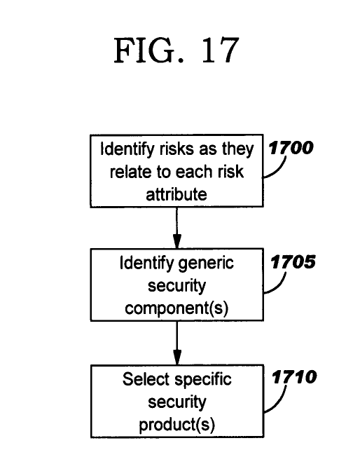

FIG. 17 illustrates, generally, the evaluation process for a pattern or for a sub-pattern. The risks as they relate to each risk attribute are identified (Block 1700), and the generic security component(s) specified in the grid of FIG. 6 which may be used to mitigate these risks are then identified (Block 1705). After identifying the generic security components, one or more specific security products can then be selected (Block 1710). The tolerance that an enterprise has for risk (as reflected in the Enterprise Assurance Level cells, for example) may be balanced against the cost of deploying the risk-mitigating products.

Programmatic tools may be used to assist in evaluating an enterprise's activities, where these programmatic tools preferably prompt a user for input and thereby lead the user through the steps shown in FIGS. 15-17. For example, a graphical user interface (“GUI”) panel may be displayed that requests the user to select one or more of the five security patterns. A textual description of each pattern may be provided to assist the user in making this selection. Having selected a pattern, a similar process may be carried out for selection of sub-patterns, where appropriate. A GUI panel may be displayed that presents the set of generic security components for each risk attribute, and the user may be allowed to select one or more of these generic security components. The programmatic tool may then use the user's selections to recommend specific security products for deployment in a security solution to mitigate risks in the selected patterns and sub-patterns.

It should be noted that while discussions herein refer to grids and cells, this is merely one form in which the present invention may be used. Alternatively, information may be represented using simple lists or other forms. In addition, when programmatic tools are used, the user may be presented with information from the GUI without that information appearing in a grid or cell format.

It may happen, in some cases, that a security solution derived using techniques disclosed herein includes products with overlapping functionality. For example, the Access Portal, Data Value, Collateral Access, and Privacy attributes may be embodied in different products that each implement authentication, authorization, and access control, and these different products require integration within the security solution in order to interoperate. (For example, such products may include Web servers, Web application servers, databases, directories, access management solutions, messaging and collaboration software, and other IT components.) In this situation, while the security solution provides effective countermeasures, its efficiency is not often optimized. The IT decision makers for the enterprise preferably include such considerations when selecting among the specific products that will form the enterprise's security solution. (Note also that the areas addressed by the Access Portal, Data Value, Collateral Access, and Privacy attributes are areas where an enterprise may have more control than in areas such as the Access Point attribute. Accordingly, the enterprise may be able to use this higher degree of control for optimizing efficiency.)

Timely management of identity life-cycle changes (whether in the organizational status of customers, partners, or employees) is key to a more effective security implementation. For example, if certain functions within an activity are to be limited to users having a particular classification, it is imperative that this classification information is kept up-to-date so that only those users presently having the required classification are able to access the function. Efficiency in this area can be improved by choosing (or developing) products where authentication, authorization, and access control are well-structured to manage identities of users, groups, and/or communities in a uniform manner across multiple patterns. An integrated approach across the patterns simplifies the user experience, as well as improving efficiency.

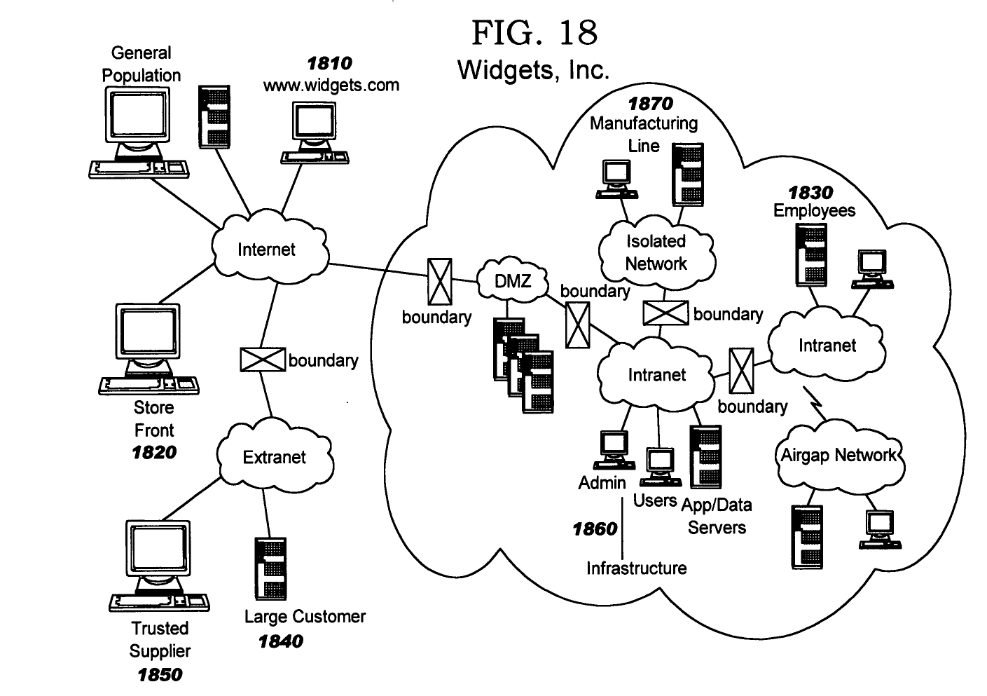

Referring now to FIG. 18, techniques disclosed herein will be discussed with reference to a fictional enterprise, “Widgets, Inc.”. As noted above, for most enterprises, the security patterns must be combined to fully represent the enterprise's activities. Accordingly, Widgets, Inc. takes advantage of many patterns to improve its business processes, work more effectively with its partners and consumers, and provide services to its employees.

In this scenario, Widgets, Inc. is a leading supplier of widgets to the worldwide market. As shown in FIG. 18, Widgets has many business interactions with a variety of people and organizations to produce and deliver its product. Widgets takes advantage of the Internet to expand its business. The interactions, systems and processes create large productivity gains, but these also introduce opportunities for attacks on Widgets' infrastructure. Therefore, Widgets has implemented a secure IT infrastructure, as shown by the presence of various firewalls forming boundaries around DMZs, use of isolated networks, and so forth.

To assume leadership in the widget industry as a key provider of services and products, Widgets uses a combination of security patterns when evaluating whether its security solution properly manages its business risk.

As shown at element 1810, Widgets provides a Web presence for the world to obtain access to data about the company. This Web presence includes information for customers, investors, and prospective employees. The Web presence projects a valuable image for the company, and Widgets wants to ensure that the image presented over the network is protected. The IT decision makers of Widgets, Inc. note during their Web presence evaluation that providing security measures for the availability and integrity of the Web presence data is important to protecting the brand image.

Now suppose that a potential customer starts interacting with Widgets at element 1810, through Widgets' Web presence. After evaluating the product selection and choosing particular items, the customer (virtually) moves to element 1820, where he begins interacting with Widgets using a B2C pattern. Widgets provides this B2C interface for small quantities of product where no formal contract exists. (A B2B interface is provided for large-scale business interactions.) As part of Widgets' growth plans, its planners see an unrealized opportunity for sales at gas stations where they can, via a kiosk model (i.e., using a purpose-optimized device), make ordering of widgets possible while consumers wait for their tanks to fill. Another aspect of B2C, used by Widgets in helping its employees manage their retirement accounts, medical benefits, payroll deductions, and other benefits, is depicted at element 1830. Widgets uses this access point for all employee activities. The IT decision makers for Widgets note, during their B2C evaluation, that all of these B2C transactions require data protection and separation.

Further suppose that Widgets, Inc. is the just-in-time manufacturing supplier for several large business partners. At element 1840, Widgets provides an interface whereby large customers can use a B2B pattern to interact with Widgets. Through this B2B interface, Widgets supplies its product in bulk, thereby allowing closer relationships to grow with its business partners. The B2B interface activities are managed by way of contracts, and provisions are made for dynamic changes in terms such as quantity and shipping schedules, as well as for other on-demand kinds of processes. This allows Widgets to react quickly as customers' needs change. Widgets has also established, as shown at element 1850, trusted-supplier relationships with some of its suppliers, enabling engineers to collaborate on designs and processes. Widgets IT decision makers note during their B2B evaluation that securing these key business processes protects the companies and allows for close relationships to exist with reduced risks.

As with any company, Widgets needs to manage its internal IT infrastructure. As shown generally at element 1860, Widgets provides operational security for employees' machines, their access capabilities, the network, data center, and so forth. This becomes both a competitive and productivity issue for employees. Element 1870 identifies the manufacturing floor, where Widgets' tightly-constrained capacity requires continuously-operating manufacturing processes. Any failure of these processes leads directly to irreversible revenue losses. These systems fall under much stricter controls than the normal operational systems. Widgets' IT decision makers conclude that today, an implementation of a high assurance pattern would be cost prohibitive. However, they foresee a time when higher levels of security functions will need to be deployed for mission-critical systems. As the security evaluations are iteratively performed over time, countermeasures for these mission-critical systems will be repeatedly reviewed.

Using techniques disclosed herein, the IT decision makers for Widgets, Inc. identify generic security components and specific security products to address the risks for the company's varying business aspects. Using a composite set of security patterns enables the decision makers to isolate risks involved with varying types of activities that form a complex enterprise, and to derive a security solution that meets the total security needs of the company.

As has been demonstrated, preferred embodiments assess an enterprise's security risks in view of a set of security patterns. The five security patterns described herein represent a broad segmentation of enterprise processes, business needs, and system elements. Each pattern that is applicable to the enterprise's operation is considered against the backdrop of a set of common attributes that are used, in turn, to further distinguish each pattern from a risk and security solution perspective. Using the disclosed techniques, specific security risks can be identified and appropriate security products can be selected to address those risks in a systematic manner, thereby assisting IT decision makers across a wide variety of enterprises in deriving security solutions. These security solutions will typically be more effective and efficient from a functional perspective, as well as being more cost-effective, than security solutions created using prior art ad hoc approaches.

The disclosed techniques may also be used advantageously in methods of doing business. In one aspect, these techniques may be leveraged in a third-party security evaluation service. For example, an enterprise's IT decision makers may be consulted by third-party evaluators on matters such as which patterns and sub-patterns best characterize the enterprise's activities, any enterprise-specific deviations from the general characterizations illustrated by FIGS. 5-14 (including, in particular, the level of risk that is tolerable to the enterprise), any budgetary constraints of this enterprise, and so forth. The third-party evaluators may then identify the generic security components which are appropriate for this enterprise and select specific security products (including multi-element security products, when applicable) for this enterprise's security solution. Fees may optionally be charged for a service of this type. As an alternative to providing a third-party evaluation service, an evaluation tool may be provided that assists in carrying out these operations. Various revenue models may used for a fee-based service, such as pay-per-use billing, a subscription service, monthly or other periodic billing, and so forth.

As will be appreciated by one of skill in the art, techniques of the present invention may be embodied as methods, systems, or computer program products, and an implementation of techniques disclosed herein may take the form of a computer program product which is embodied on one or more computer-readable media (including, but not limited to, disk storage, CD-ROM, optical storage, and so forth) having computer-usable program code embodied therein.

While preferred embodiments of the present invention have been described, additional variations and modifications in those embodiments may occur to those skilled in the art once they learn of the basic inventive concepts. Therefore, it is intended that the appended claims shall be construed to include preferred embodiments as well as all such variations and modifications as fall within the spirit and scope of the invention.

1. A method of analyzing security needs of an enterprise, comprising steps of:
determining which of a plurality of patterns characterizes the enterprise's activities;
analyzing the enterprise's activities according to a plurality of attributes of the determined patterns to identify risks involved with the activities;
identifying, for the identified risks, one or more security components that are appropriate for addressing those risks; and
selecting, from among candidate security offerings, one or more security offerings that fulfill needs indicated by the identified security components.

2. The method according to claim 1, wherein the selected security offerings are candidates for inclusion in the security solution for the enterprise.

3. The method according to claim 1, wherein the identified security components are taken from a predetermined set of security components that are appropriate for addressing risks.

4. The method according to claim 1, wherein the candidate security offerings are commercially-available security products.

5. The method according to claim 1, wherein the candidate security offerings comprise security products and security services.

6. The method according to claim 4, wherein the candidate security products comprise at least one of (1) one or more hardware products and (2) one or more software products.

7. The method according to claim 1, wherein the candidate security offerings comprise security products, security services, and non-technical security measures.

8. The method according to claim 7, wherein the non-technical security measures include contract terms to address one or more security risks.

9. The method according to claim 1, wherein the patterns are predetermined security patterns.

10. The method according to claim 1, wherein the attributes are predetermined risk attributes.

11. The method according to claim 1, wherein at least one of the patterns has a plurality of sub-patterns, and wherein the determining and analyzing steps apply also to the sub-patterns.

12. The method according to claim 1, further comprising the step of charging a fee for performing one or more of the determining, analyzing, identifying, and selecting steps.

13. The method according to claim 1, wherein the analyzing step further comprises steps of:
reviewing a predetermined set of risks which are characteristic for each determined pattern;
determining any enterprise-specific deviations from the predetermined set of risks; and
including the enterprise-specific deviations in the identified risks.

14. The method according to claim 1, wherein at least one of the security components is a multi-element security component that applies to more than one of the attributes.

15. A method of deriving a security solution for an enterprise, comprising steps of:
determining which of a plurality of patterns characterizes the enterprise's activities;
analyzing the enterprise's activities in each determined pattern according to a plurality of attributes, thereby identifying risks involved with the activities;
selecting, from among candidate security offerings, one or more security offerings that fulfill needs indicated by one or more security components that are appropriate for addressing the identified risks; and
using the selected security offerings as candidates for inclusion in the security solution for the enterprise.

16. A method of evaluating security of an enterprise, comprising steps of:
determining which patterns and sub-patterns best characterize the enterprise's activities;
determining risks which are attributable to each of the determined patterns and sub-patterns;
identifying one or more security components which are appropriate for addressing the determined risks;
selecting at least one security product or security service associated with the identified components; and
charging a fee for carrying out one or more of the steps of determining patterns and sub-patterns, determining risks, identifying, and selecting.

17. A system for analyzing security needs of an enterprise, comprising:
means for determining which of a plurality of patterns characterizes the enterprise's activities;
means for analyzing the enterprise's activities according to a plurality of attributes of the determined patterns to identify risks involved with the activities;
means for identifying, for the identified risks, one or more security components that are appropriate for addressing those risks; and
means for selecting, from among candidate security offerings, one or more security offerings that fulfill needs indicated by the identified security components.

18. The system according to claim 17, wherein the selected security offerings are candidates for inclusion in the security solution for the enterprise.

19. A computer program product for analyzing security needs of an enterprise, the computer program product embodied on one or more computer-readable media and comprising:
computer-readable program code means for determining which of a plurality of patterns characterizes the enterprise's activities;
computer-readable program code means for analyzing the enterprise's activities according to a plurality of attributes of the determined patterns to identify risks involved with the activities;
computer-readable program code means for identifying, for the identified risks, one or more security components that are appropriate for addressing those risks; and
computer-readable program code means for selecting, from among candidate security offerings, one or more security offerings that fulfill needs indicated by the identified security components.

20. The computer program product according to claim 19, wherein the selected security offerings are candidates for inclusion in the security solution for the enterprise.

21. A method of identifying functional requirements for a security product, comprising steps of:
determining which of a plurality of patterns characterizing an enterprise's activities is to be addressed by the security product;
identifying, for each determined pattern, risks involved with the activities by evaluating the activities according to a plurality of attributes;
selecting, from among the identified risks, each risk to be addressed by the security product; and
compiling the selected risks as the functional requirements for the security product.
